(19) United States
(12) Patent Application Publication
(10) Pub. No.: US 2002/0071797 A1
(43) Pub. Date: Jun. 13, 2002

(54) Catalytic separator plate reactor and method of catalytic reforming of fuel to hydrogen

(76) Inventors: Daniel G. Loffler, Palo Alto, CA (US); Carlos F. Faz, Hayward, CA (US); Valery Sokolovskii, San Jose, CA (US); Enrique Iglesia, Moraga, CA (US)

Correspondence Address: Jacques M. Dulin, Esq., Innovation Law Group, Ltd., Suite 101, 851 Fremont Avenue, Los Altos, CA, 94024, US

(21) Appl. No.: 09/737,268

(22) Filed: Dec. 13, 2000

Related U.S. Application Data
(60) Provisional application No. 60/238,867, filed on Oct. 6, 2000.

(51) Int. Cl. B01J 8/04; B01J 10/00; F28D 1/00

(52) U.S. Cl. 422/190; 422/189; 422/198

(57) ABSTRACT

Modular, stackable, flow-through plate or channel reactor units for continuous, low temperature, catalytic reactions of two separate process reaction streams; typically the first is an exothermic combustion process and the second, an endothermic reforming process. Each reactor unit comprises two separate sets of flow channels or slot-type reaction zones formed in flow plates located between spaced, thin metal, highly heat-conductive metal foil or platelet separator walls, adjacent reactors in a stack including a common, medially located, bi-catalytic separator plate, i.e., a separator plate having on opposed surfaces the same or different catalysts selected for the particular reaction taking place in the adjacent reactor zone. Each flow plate has a relieved medial area defining the reaction zone, the side walls of which are the catalyst coated separator platelets. A separator platelet thus separates two adjacent reaction zones, one on each side and functions to transfer heat from the combustion occurring at the catalyst surface in the combustion zone directly to the reforming catalyst coated on the opposed surface. The reaction zones may include structures such as grooved plates or packed spheres to direct the feedstock gases to the catalyst coated on the platelet surfaces. Support frames, gaskets, manifolding, insulating spacers, end plates and assembly hardware and methods are also disclosed. Multiple modular reactor units or cells may be stacked to provide a reactor of any desired throughput capacity and portability. The invention also comprises methods for the catalytic reforming of hydrocarbon fuels for the production of synthesis gas or hydrogen employing the bi-catalytic reactor of the invention.

### FIELD OF THE INVENTION

The invention relates to plate or channel-type reactors using integrated bi-catalytic heat transfer separator walls, each wall surface containing or having coated thereon a selected catalyst. The reactor provides for continuous and simultaneous reaction of two different process reaction streams in the channels defined between the walls, wherein a first process reaction stream undergoes high temperature exothermic reaction in a first channel and a second process reaction stream undergoes an endothermic heat-consuming reaction in a second channel separated from the first by the heat transfer separator wall. The heat produced by catalytic oxidation of fuel in the first channel is transferred to the second channel where a catalytic reforming reaction takes place. Multiple modular catalyst coated separator wall units or cells may be stacked to provide a reactor of any desired throughput capacity and portability. This invention also comprises methods for the catalytic reforming of hydrocarbon fuels for the production of synthesis gas or hydrogen employing the bi-catalytic reactor of the invention.

### BACKGROUND

The steam reforming of hydrocarbon fuels for the production of synthesis gas or hydrogen is a well-established technology. A common process is steam reforming, where a suitable reforming catalyst facilitates the reaction between the hydrocarbon feed and steam to generate carbon monoxide and hydrogen. Conventional steam reformers consist of a reforming section containing the catalyst and a burner to supply heat for the endothermic reforming reaction. Steam and a hydrocarbon fuel are supplied to the reforming section, and the product hydrogen must be separated from the carbon monoxide.

A typical industrial reformer contains multiple tubes made of refractory alloys. The tube interiors constitute the reaction zone and they are packed with porous pellets of material impregnated with a suitable reforming catalyst. The tube diameter varies between 9 and 16 cm and the heated length of the tube is normally between 6 and 12 meters. The tubes are mounted in a furnace with burners that heat the reaction zone to a temperature that is typically as high as 1300° C. in order to insure that the temperature of the catalyst in the tubes is around 700° C. The burner operates at temperatures considerably higher than the temperatures required by the reforming reaction because the combustion gases must transfer the heat of reaction through the reactor wall to the reforming gases and to the catalyst pellets in which the reaction takes place. High burner temperatures are necessary in order to insure that the reforming catalyst operates at the desired temperatures. One undesired consequence of those high burner temperatures is the production of NOₓ in the combustion flue gases. In addition, because a gaseous stream transfers the heat of reaction, the volume of the furnace is necessarily large.

Equally important, such industrial reformers can not be scaled to smaller sizes for modular portable units in order to provide sufficient hydrogen-rich gas for fuel cells or chemical reaction processes. For example, modular portable fuel cells are envisioned for residential and small business electrical production and water treatment using fuel cells, and they are of particular interest in remote and arid areas and in undeveloped countries, which lack a power grid, technological capability, and the funds for an electricity distribution infrastructure. Another area of interest is for transportation power, particularly for vehicle fuel cells for hybrid vehicle power trains, for mass transit vehicles and trucks. Because of the safety and volume constraints, high purity hydrogen in pressurized tanks is presently not desirable for vehicle fuel cells. Accordingly, the current best solution is to use liquid hydrocarbons, such as LNG, condensed methane, or liquid volatile fuels, such as alcohols or motor grade gasoline, kerosene, benzene, or the like in order to feed an on-board reformer and produce a hydrogen-rich effluent as feedstock for such fuel cells.

To solve those problems, plate-type reformers, which are compact in size, and within which catalytic combustion at low temperatures is possible, have been proposed. An example of such plate reformers is described in U.S. Pat. No. 5,015,444 of Koga et al. The reformer described therein has alternating flat gap spaces for a fuel/steam mixture and a fuel/air mixture. The combustion gap spaces are filled with a combustion catalyst, while the reforming gap spaces are filled with a reforming catalyst. The catalytic combustion of the fuel/air stream provides the required heat for the reforming of the fuel/steam mixture stream at temperatures substantially lower than 1300° C.

U.S. Pat. No. 5,167,865 of Igarashi et al describes a more compact embodiment of the plate reactor. Igarashi et al proposed a rectangular wall reactor consisting of alternating stages comprising a heated reformer area separated from a conductive heating area. Each stage comprises a plurality of plates, e.g. three plates, a pair of spaced boundary plates and a center partition plate, the spaces between the partition and boundary plates being respectively the heated reformer area and the conductive heating area. A catalyst is deposited by electroless plating on the reformer side of the separator.

These prior art plate reactors to date have not been widely adopted by the art, and they appear to present the following types of concerns and problems: In U.S. Pat. No. 5,015,444 of Koga et al., the combustion and reforming catalysts are in the form of powders or pellets filling the gaps between plates. The catalytic materials are not adhered to the partition walls; hence, the heat generated on the combustion catalyst must be transferred to a gas phase before reaching the reforming catalyst. As stated above, because a gaseous stream transfers the heat of reaction, the volume of the reactor is consequently large. In U.S. Pat. No. 5,167,865 of Igarashi et al., the reforming catalyst is deposited on the wall of the reforming channel. Thus, the heat of reaction is transferred from the channel wall to the catalyst in the reforming channel through the channel wall only, and a fluid-solid heat transfer step still must take place in the combustion channel.

Verykios, X. E. and lonnides, T., in Catalysis Today, Vol. 46, No. 2-3, pp. 71-81 (1998) described another integrated heat transfer reactor. This reactor consisted of a hollow ceramic tube within a ceramic test-tube shaped well, with both the inside and outside surfaces of the hollow tube coated with similar or different metal catalyst films. The methane/oxygen feed enters into the hollow center core of the inlet tube, and reacts by contact with the first combustion catalyst film, then passes out the inner end of the tube, reversing direction and passing along the annulus between the inlet tube and the well where it contacts the reforming catalyst. A large fraction of the heat generated on the inlet tube inside wall by combustion was transported across the ceramic tube wall towards the outer catalyst film, where the endothermic reforming reactions occurred. In this reactor, the heat of combustion is transferred from the combustion catalyst to the reforming catalyst only though solid, relatively thick walls. This should result in a more compact design; however, this reactor is just a laboratory-scale unit that does not scale-up well.

Accordingly, there is a need in the art for an improved plate-type reformer with the inherent size advantages of the hollow ceramic tube reactor, but without the scale-up difficulties present in that design.

### THE INVENTION

Summary, Including Objects and Advantages

The present invention is directed to a modular, stackable unit, flow-through plate or channel reactor for continuous, low temperature, catalytic reactions of two separate process reaction streams; typically the first is an exothermic combustion process and the second, an endothermic reforming process. The reactor consists of two separate sets of flow channels or slot-type reaction zones located between spaced, thin metal, highly heat-conductive separator walls, and which includes a common, medially located, bi-catalytic separator plate, i.e., a separator plate having on opposed surfaces the same or different catalysts selected for the particular reaction taking place in the adjacent reactor zone. The channels are configured and manifolded for simultaneous passage of the different process reaction streams, in co-current, countercurrent, or cross-flow modes. The combustion process reactant stream leads to a high temperature exothermic reaction in the presence of a selected catalyst coated on at least a portion of the first channel wall, preferably the medial wall surface facing the combustion zone. The reforming process reaction stream simultaneously undergoes an endothermic reaction, also in the presence of a catalyst coated on at least a portion of the second channel wall, again preferably on the medial separator plate surface facing the reaction zone.

This invention is particularly characterized as an apparatus and process for low temperature bi-catalytic combustion/reforming with low NOx formation, and more particularly with respect to the apparatus, to a reactor system employing modular, stackable bi-catalytic cell units having separate flow streams in intimate heat transfer relationship; these streams may be used in co-flow, counter-flow or cross-flow. No open flame combustion is involved. The reactant gases flow streams may be routed through any one or more of open volume flow, or continuous sinusoidal, parallel, or separate inter-digitated channels for precise flow control and heat transfer management without hot spots. A plurality of the bi-catalytic modular reactor units or cells may be assembled and bolted together into a stack, the size of which is determined on the output requirements and/or portability. Alternately, the modular cell units may be bonded together to form a monolithic reformer stack.

The flow paths are configured in the reactor apparatus with the first set of flow channels adjacent to and in intimate heat exchange with the second set of flow channels through a common channel wall. It is preferred that the catalytic surfaces in each cell be in opposed relationship. That is, the catalyst surface in one channel-type reaction zone is directly on the opposite side of a common separator plate on the other side of which is disposed the catalytic surface of the other channel/reaction zone, such that the exothermic heat of reaction generated by the catalyst in the first set of flow channels is conductively transferred directly through the separator plate to the catalyst for the endothermic reaction in the second set of flow channels. In a preferred embodiment of this invention, the flow-through reactor is used to carry out simultaneous catalytic combustion of methane and catalytic methane reforming. The catalyst concentration/catalytically active surface area is balanced between the two sets of channels such that the heat generated by the exothermic reaction is entirely consumed by the endothermic reaction, thereby avoiding the presence of hot spots or heat imbalances on the catalytic surfaces that may deactivate or sinter if exposed to high temperatures.

### BRIEF DESCRIPTION OF THE DRAWINGS

The accompanying drawings, which are incorporated into and constitute a part of this specification, illustrate one or more exemplary, non-limiting embodiments of the invention and together with the description, serve to explain the principles of the invention. In the drawings:

FIG. 1 is an exploded view of a first embodiment of three representative reaction zone modular cells of the present invention in a reformer stack showing the flow manifolding for both the catalytic combustion and the catalytic reforming zones of the reactor;

FIG. 2 is an exploded isometric view of an embodiment of two bi-catalytic separator plates and their associated combustion and reforming flow plates in modular assembly sequence for cells in a reformer stack of the present invention;

FIG. 3 is an exploded isometric view of an alternative embodiment of a pair of transverse-flow plate sub-assemblies employing support frames and gaskets to permit sealing to the bi-catalytic separator plate;

FIG. 4 is a section view taken along the line 4-4 in FIG. 3 illustrating the support area provided to the gasket by the frame plate of the FIG. 3 embodiment;

FIG. 5 is an enlarged isometric view of a portion of a transverse-flow plate fitted with a grooved flow-directing member or insert;

FIG. 6 is an enlarged isometric view of a transverse-flow plate fitted with a flow-redirecting member or insert in the form of a layer of spheres;

FIG. 7 is a schematic exploded isometric view of a multi-cell plate reformer of the invention in completed stack configuration;

FIG. 8 is a temperature and conversion graph showing the operation of the invention using a Pd-containing catalyst for combustion and reforming; and

FIG. 9 is a temperature and conversion graph showing the operation of the invention using a Pd catalyst for combustion and an Rh catalyst for reforming.

### DETAILED DESCRIPTION, INCLUDING THE PRESENT BEST MODES OF CARRYING OUT THE INVENTION

The following detailed description illustrates the invention by way of example, and it is not in any way intended to limit the principles of the invention. This description will clearly enable one skilled in the art to make and use the invention, and it describes several embodiments, adaptations, variations, alternatives and uses of the invention, including what is currently considered to be the best modes of practicing the invention.

In this regard, the invention is illustrated in the figures enclosed herein, and it is of sufficient complexity that the many parts, interrelationships, and sub-combinations thereof simply cannot be fully illustrated in a single patent-type drawing. For clarity and conciseness, several of the drawings show in schematic form, or omit parts that are not essential in this drawing to a description of a particular feature, aspect or principle of the invention being disclosed. Thus, the best embodiment of one feature may be shown in one drawing, and the best mode of another feature will be called out in another drawing.

Likewise, in regard to the chemical process aspects, the invention is illustrated in the several examples, and is of sufficient complexity that the many aspects, interrelationships, and sub-combinations thereof simply cannot be fully illustrated in a single example. For clarity and conciseness, several of the examples show, or report only aspects of a particular feature or principle of the inventive process, while omitting those that are not essential to or illustrative of that aspect. Thus, the best mode embodiment of one aspect or feature may be shown in one example or test, and the best mode of a different aspect will be called out in one or more other examples, tests, structures, formulas, or discussions.

All publications, patents and applications cited in this specification are herein incorporated by reference as if each individual publication, patent or application has been expressly stated to be incorporated by reference.

Reference will now be made in detail to the presently preferred embodiments of the invention, examples of which are illustrated in the accompanying drawings. Wherever possible, the same reference numbers will be used throughout the drawings to refer to the same or similar parts. The present invention is described below by way of example by reference to its application to catalytic reforming of hydrocarbon fuels for the production of synthesis gas or hydrogen.

A. Catalytic wall plate reactor

The plate reactor of this invention comprises plural modular cells of the same or corresponding cooperating units, which include medial separator plates coated with combustion and reforming catalysts, stacked in coordinate relationship in sub-assembly units along with a transverse flow plate on each side of the bi-catalyst coated separator plate, so that there is at least one transverse-flow plate assembly between two combustion-catalyst-coated separator plate faces and at least one transverse-flow plate assembly between two reforming-catalyst-coated separator plate faces.

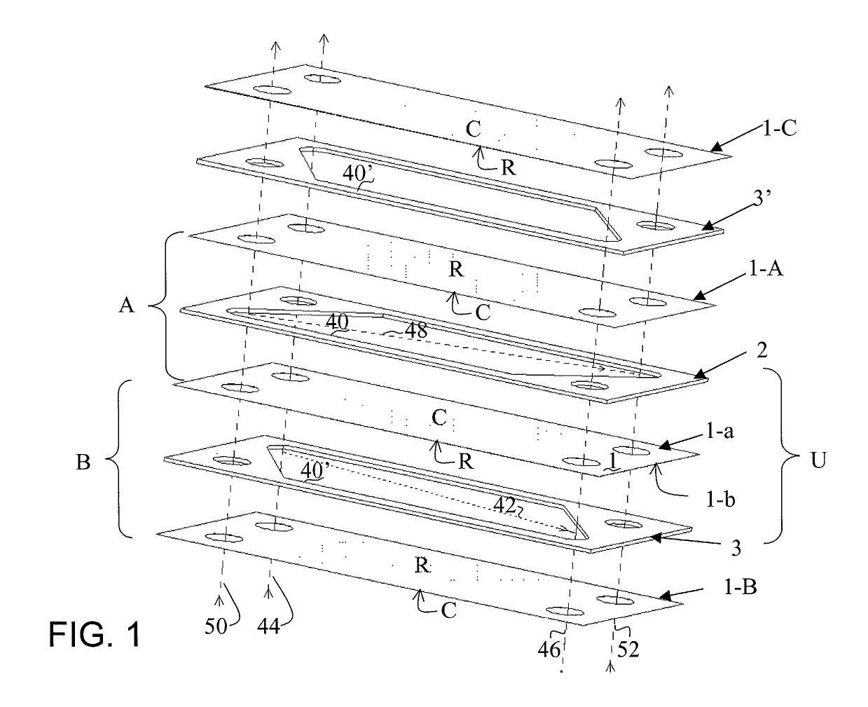

FIG. 1 is an isometric exploded view representative of an internal section of a reformer stack, showing multiple modular bi-catalytic separator plate reactor cells. A single cell of a plate reactor of the invention comprises a main unit U, in which reforming and combustion take place. A thin separator plate 1 is coated with a combustion catalyst, C, on face 1a and with a reforming catalyst, R, on face 1b. Transverse-flow plates or frames 2 and 3 include hollow sections 40, 40′ for passage of the combustion gases and reforming gases, respectively.

In the stack of these bicatalyst flow plate units or cells U, the combustion transverseflow plate 2 contacts a combustion-catalyst-coated face C of an adjoining unit's separator plate 1-A, while the reforming transverse-flow plate 3 is arranged so as to contact a reforming-catalyst-coated face R of an adjoining unit's separator plate 1-B. Thus, the reformer stack contains a plurality of alternating channel or slot-type combustion reaction zones A and reforming zones B separated by thin bi-catalyst-coated separator plates 1, 1-A, 1-B, 1-C . . . 1-N. Dashed arrow 42 shows the flow of the reforming gas from the reforming gas inlet via 44 to the reformer outlet via 46, at which point the gas is hydrogen-rich as a result of the reaction at the catalyst coated surface R on face 1b of plate 1. Similarly, the dashed arrow 48 shows the flow of the combustion gas from the combustion gas inlet via 50 combustion exhaust gases outlet 52. The alternating orientation of the bi-catalyst plates can be characterized as the following arrangement, where R represents the reforming reaction catalyst, and C the combustion catalyst, the slash represents the separator plate, and the space represents the channel or reaction zone: R/C C/R R/C C/R . . . R/C. It should be understood that the reforming and the combustion catalysts can be closely similar, if not identical, so that the designation R and C refer to their functionality in the specific chemical environment present in the two opposite sides of each plate.

B. Catalytic separator plate reactor assembly.

The bi-catalytic separator plate reactors shown in FIG. 1 can be assembled by joining the bi-catalytic separator plates and transverse-flow plates together, e.g., by clamping or bolting (using appropriate through-bolts, not shown), or preferably by brazing or diffusion bonding under pressure. Alternatively, the reactor can be assembled by means of gaskets arranged between the bi-coated plates and the transverse-flow plates. The brazed structure is lightweight and compact, but not disassembled easily for cleaning, inspection or catalyst replacement. Use of gaskets for sealing results in a bulkier and heavier structure that, however, can be easily opened to access the catalyst for maintenance, cleaning or replacement.

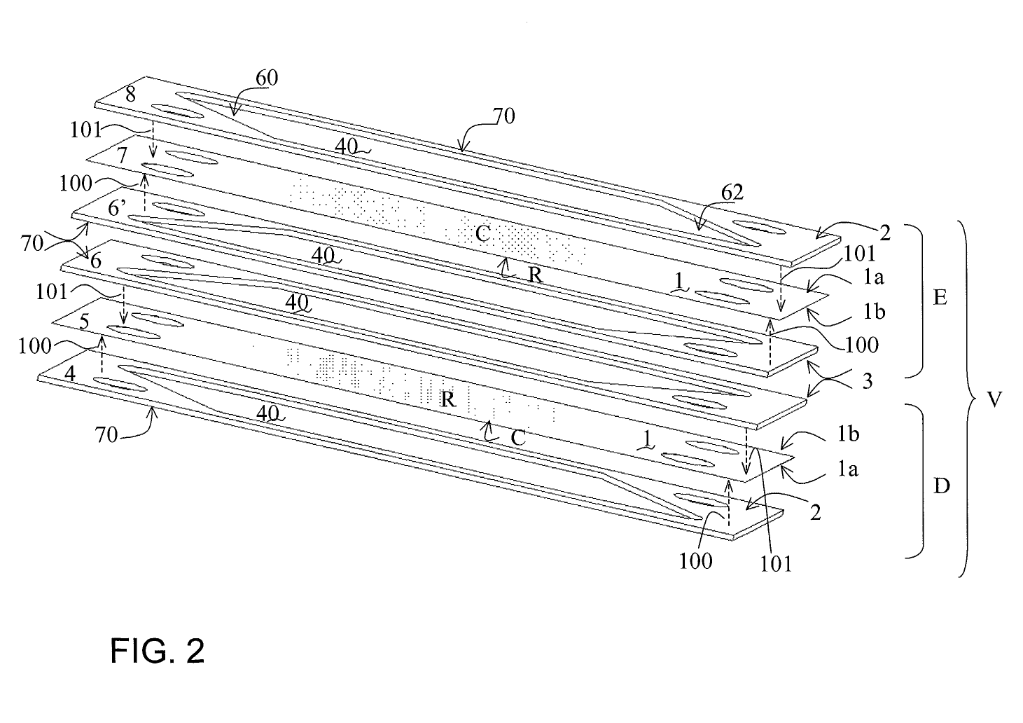

Brazing. The metal surfaces to be brazed must be clean for the metal parts to adhere. Since the process for depositing the catalytic coatings on the plates results in the oxidation of the surface of the plates, brazing methods can not be used without first cleaning the surfaces to be joined. Aggressive mechanical or chemical treatments are needed to eliminate the oxide layer. Those treatments can damage the thin metal separator plate 1. Also, referring now to FIG. 2, the intake and outlet regions 60, 62 of the entry and exit openings to the gas flow channels form the weakest point of the separator plate/transverse-flow plate joint. In those regions, the thin metal bi-catalyst separator plate is joined to a transverse-flow plate only on one side. One approach to insure proper adhesion when brazing is to use solid inserts that may be placed in the transverse flow plate entries 60 and exits 62 to press the separator plate against the transverse-flow plates. However, removing such inserts, after brazing the sub-assemblies and before assembling the cells into a finished stack, is difficult and leads to low sub-unit production yields.

Thus, according to another aspect of the present invention, a good seal is obtained while obviating both cleaning the oxidized separator plate and the use of brazing inserts. This aspect of the present invention is illustrated in FIG. 2, and is accomplished in a first method of assembly embodiment by brazing the transverse-flow plates 2, 3 to the separator plates 1, 1′ prior to coating with catalyst as shown by dashed arrows 100 and 101. Thus, only fresh, clean surfaces are brazed to form sub-assemblies consisting of a separator plate sandwiched between two transverse-flow plates, sub-assemblies D and E of FIG. 2. After the catalyst coating is deposited on the area of the separator plates that is exposed in the channel opening 40 of the sub-assemblies, the sub-assemblies D and E (and others like them) are stacked to form the plate reactor structure. Any oxide layers formed on unintended surfaces of the subassemblies after depositing the catalyst coatings (e.g., the faces of the plates 2 and 3) are easily removed without damage as the removal is from the exterior faces of the relatively thick transverse flow plate frames 2, 3, rather than from the very thin separator plate 1.

FIG. 2 is an exploded isometric view of a sub-assembly suitable for joining by brazing. Fresh metal transverse-flow plates 4 and 6 are joined by brazing to a fresh thin metal separator plate 5 to form sub-assembly D. Similarly, fresh metal transverse-flow plates 6′ and 8 are joined to a fresh thin plate 7 to form sub-assembly E. Sub-assemblies D and E are treated to coat portions of the exposed surfaces of the thin plates 5 and 7 corresponding to the reaction zone areas 40 with reforming and combustion catalysts. Sub-assemblies D and E are thick enough that the exposed surfaces 70 of the transverse-flow plates can be cleaned without compromising the physical integrity of the subassemblies. Once the surfaces are clean, sub-assemblies D and E are joined by brazing to form a double unit V. Unit V is similar to unit U in FIG. 1 except there are two transverse flow plates, 6 and 6′ joined together in the center of unit V. That is, the transverse flow plate can be constructed of two or more thinner platelets. As shown, the unit V has on both its top and bottom the C side of the separator plate exposed. Corresponding units can be constructed having both R side catalysts exposed, or the termination plate can be a separator plate so the unit has alternate catalyst ends, as needed. Multiple cells of the various types of sub-assembly V units can be assembled into a stack that contains a plurality of alternating combustion and reforming channel-type reaction zones. The stack includes end insulators and end plates, with appropriate through holes and fastening bolts (not shown as they are conventional).

1. Gasket sealing. According to a second construction and assembly aspect of the present invention, a safe seal can be provided between the separator plate and transverse-flow plates by means of gaskets of suitable materials, such as flexible, compressible graphite, ceramic or vermiculitic materials. The use of gaskets allows easy inspection and replacement of the plates. Accordingly, the gasketed assembly is the preferred embodiment of cells and stacks of the invention for the purpose of testing catalysts.

The relieved intake and outlet regions 60, 62 to the entry and exit ends of the gas flow channels 40 will not provided adequate support to permit a good seal to the separator plate. The resulting reduced gasket pressure results in the probability that leakage may occur in this region. According to a second design and assembly aspect of the present invention, this leakage problem is solved by use of metal frames that sandwich the transverse-flow plates to provide the necessary metal support for the gaskets to safely seal.

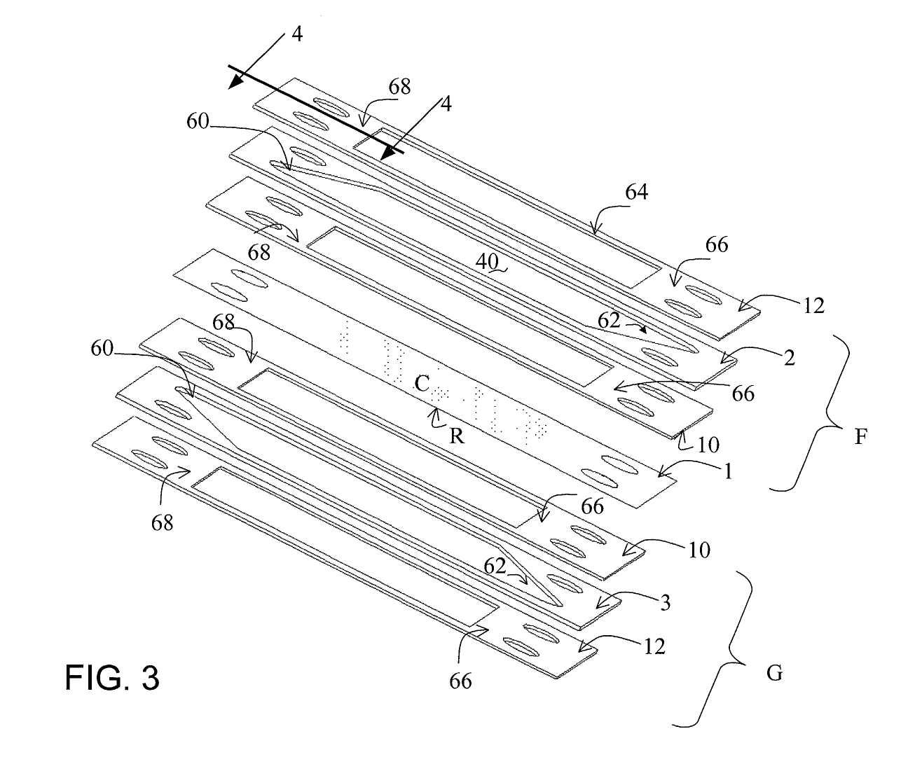

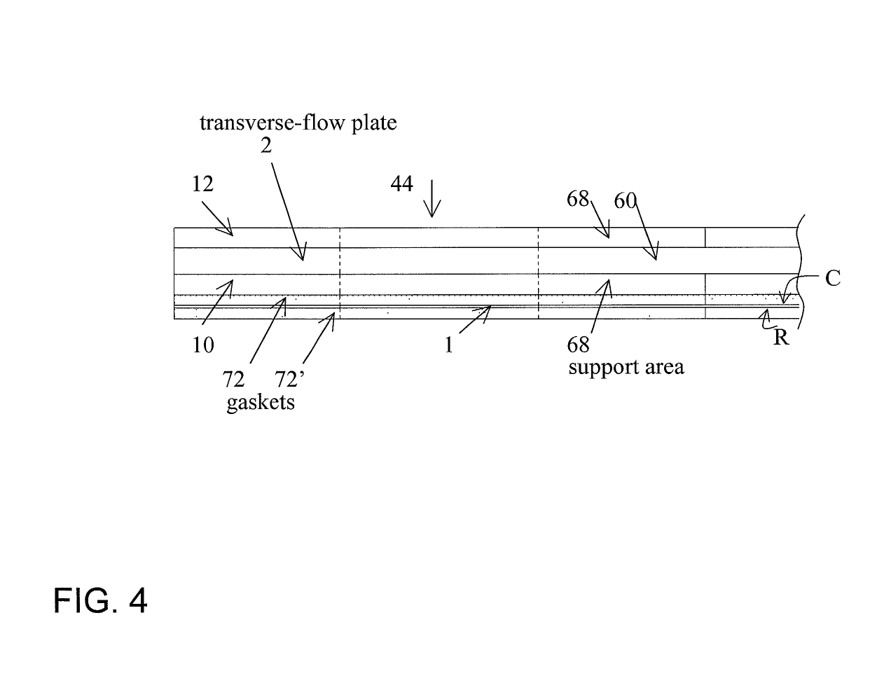

FIG. 3 is an exploded isometric view of a sub-assembly comprising a transverse-flow plate or platelet 2 and two metal plate or platelet frames 10 and 12. Metal frames 10 and 12 are joined by brazing to transverse-flow plate 2 to form unit F. Unit F is similar to transverse-flow plate 2 in FIG. 1, and it may be use in place of that transverse-flow plate. Following a similar procedure, a unit G similar to transverse-flow plate 3 in FIG. 1 can be assembled. In the partial stack of FIG. 1, gaskets made of a suitable material (Grafoil brand flexible sheet graphite, Vermiculite, Ti foil, Nitrided Ti) reproducing the shape of the metal frames 10 are placed between the unit F and face 1a of the thin separator plate 1, and between the unit G and face 1b of the thin separator plate 1. For clarity, the gaskets are not shown in FIGS. 1, 2 or 3, but they are shown in FIG. 4, and described in more detail below. The gaskets are similar in shape to the plates 10, 12 and they are inserted between those plates and the corresponding separator plates. Note that the areas 66, 68 of the plates 10, 12 support, respectively, the relieved areas 62, 60 of the transverse flow plates 2, 3, respectively. Thus, this embodiment of the inventive plate reformer is sealed with gaskets for easy assembly and disassembly.

FIG. 4 is a section view through line 4-4 of FIG. 3, and it shows the metal support frames 10, 12 sandwiching the transverse flow plate 2. Frame 10 is in contact with a gasket 72, such as flexible compressible graphite, (e.g., Grafoil brand flexible sheet graphite sealing material) which in turn is in contact with the thin metal bi-catalyst coated separator plate 2. The bore 44 permits introduction of the combustion gas, which passes into the flow channel 40 via the relieved portion 60 of the transverse flow plate 2. The bottom gasket layer 72′ would be in contact with a support frame 10 of the unit G (see FIG. 3).

C. Flow Redirecting Devices

Efficient operation of the plate reformer requires thorough contact of the gas streams with the catalytic walls. Redirecting the gas flow towards the catalytic wall enhances contact between the gas stream and the catalytic wall. Thus, according to a third aspect of this invention, flow-redirecting devices are introduced within the inter-plate voids 40 of transverse-flow plates 2 and 3 in FIGS. 1-3.

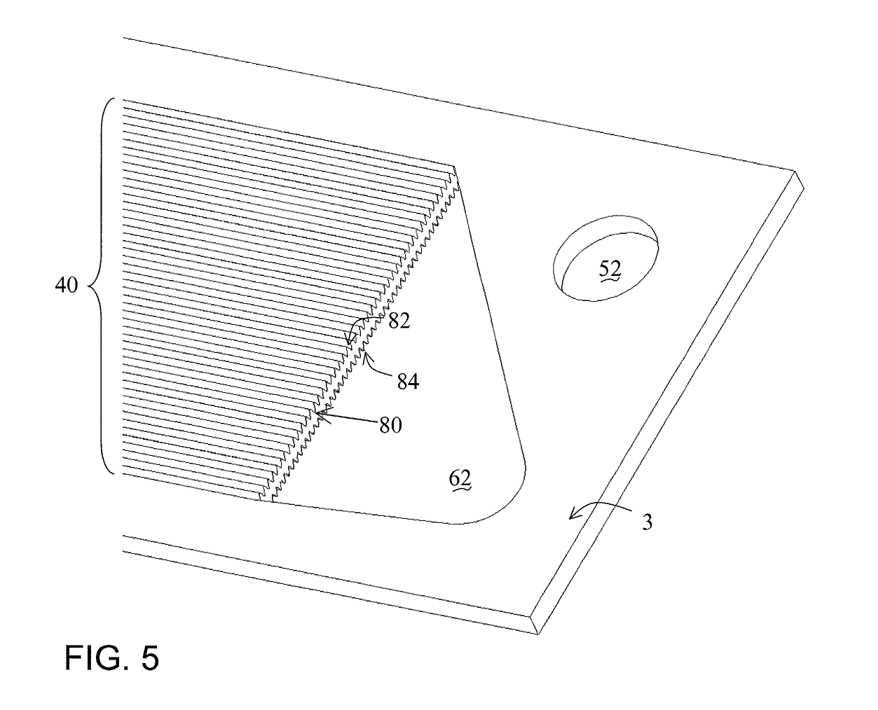

FIG. 5 is an enlarged isometric view of a grooved plate flow-redirecting device 80 placed in the void 40 of the transverse flow plate 3. At least one, and preferably both faces 82, 84 of the insert 80, are grooved to provide passage for the gas to be directed to flow close to the catalytic wall. The insert material may be any suitable temperature-resistant inert material such as stainless steel, titanium, nitrided titanium, block graphite, ceramic, cer-met, or combinations thereof. In addition, the grooved surfaces can be coated with catalyst before insertion in the void area 40. The grooves can be any suitable longitudinal and cross-sectional shape, such as sinusoidal, V-bottomed, semicircular, U-bottomed or square cut, and the like.

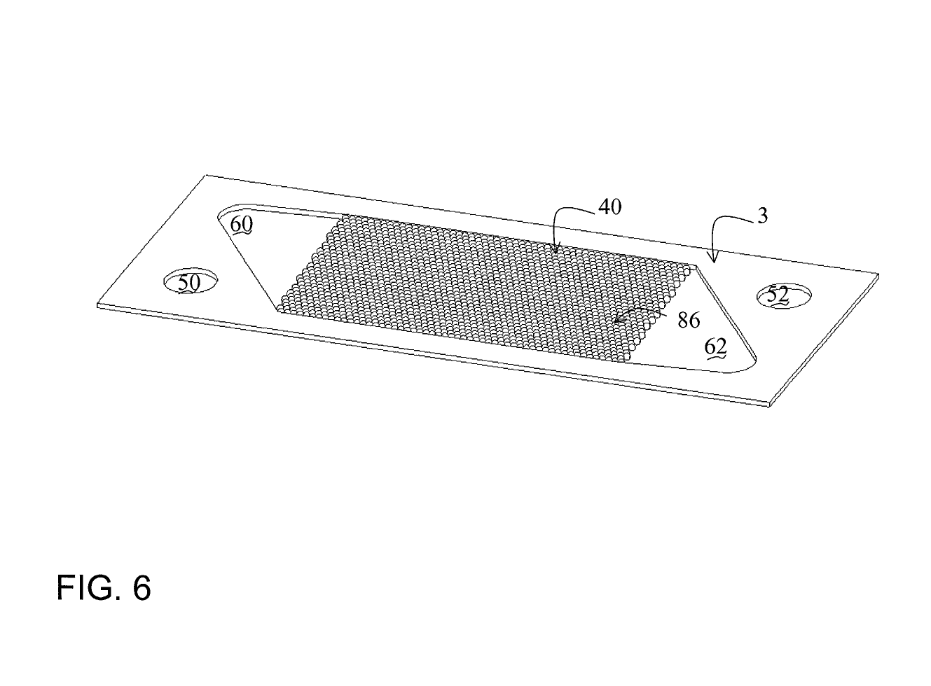

A second type of flow-directing device is shown in FIG. 6. The void 40 in the transverse-flow plate 3 is filled with spheres 86 to redirect the gas flow towards the catalytic walls. Preferably the spheres are fused together at contact surfaces to form a rigid insert, rather than the void 40 being filled with loose spheres.

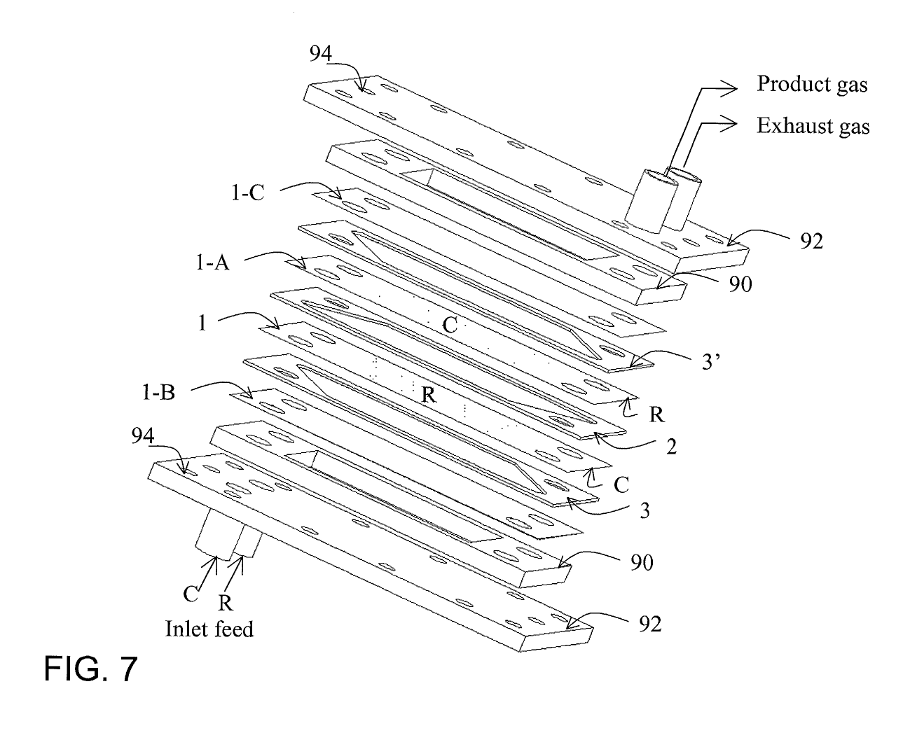

FIG. 7 is an isometric exploded view of a complete reformer stack showing the orientation of the plates as called out in FIG. 1, and with the addition of insulation spacers 90 and end plates 92 at each end. The insulation spacers provide an insulating void that optionally can be filled with insulating material. The separator plates 1-C and 1-B need not, but may be coated with catalyst C. The inlets and outlet feed and exhaust pipes are shown in FIG. 1. In addition, bolt holes 94 are spaced around the periphery of the end plates and aligned so that fastening rods may be inserted an tightened down with nuts (not shown).

It is recognized that those skilled in the art may make various modifications or additions to the present best mode embodiments of the apparatus without departing from the spirit, scope and intent of the present invention and that the present invention is not limited to these preferred embodiments. For instance, positions of the passages for the gas streams, and each inlet/outlet opening for fuel, reformed gas, etc., may be changed from the positions shown in the figures. In addition, the number of units stacked in the reactor may be more than the two shown in FIG. 1 or FIG. 7. The grooves in the slab-shaped flow-redirecting device need not be straight, e.g., they may be sinusoidal, and they could have relatively sharp bends or kinks, or the depth need not be uniform or partial obstructions placed in the grooves, to induce turbulence. Finally, one or more layers of spheres may be included in the flow-redirecting device shown in FIG. 6.

The Process

The reforming process of the invention may be used with a wide variety of fuels and a broad range of process conditions. A single fuel feedstock can be fed to the reforming and combustion zones, or different fuels can be used for reforming and combustion. Although normally gaseous hydrocarbons, e.g., methane, ethane, and propane, are highly desirable as a source of fuel for the process, most carbonaceous fuels capable of being vaporized at process temperatures discussed below are suitable. For instance, the fuels may be liquid or gaseous at room temperature and pressure. Examples include the low molecular weight aliphatic hydrocarbons mentioned above as well as butane, pentane, hexane, heptane, octane, gasoline, diesel fuel and kerosene; jet fuels; other middle distillates; heavier fuels (preferably hydrotreated to remove organo-sulfuric and organo-nitrogen compounds); oxygen-containing fuels such as alcohols, including methanol, ethanol, isopropanol, butanol, or the like; and ethers such as diethylether, ethyl phenyl ether, MTBE, etc. The process is also suitable to combust hydrogen gas, either pure or mixed with hydrocarbon and/or inert gases.

Combustion Zone

The fuel is typically mixed into the combustion air in the amounts required in order to produce a mixture having an adiabatic combustion temperature preferably above 900° C., most preferably above 1000° C. Non-gaseous fuels should be at least partially vaporized before they contact the catalyst zone. The combustion air may be at atmospheric pressure or it may be compressed. In a presently preferred best-mode embodiment, the process employs catalytic amounts of palladium-containing materials on a support with low resistance to gas flow.

The fuel/air mixture supplied to the catalyst should be premixed well and the gas inlet temperature may be varied depending on the fuel used. This temperature may be achieved by preheating the gas through heat exchange, or adiabatic compression.

Both the bulk outlet temperature of the partially combusted gas leaving the zone containing the catalyst and the temperature of the wall which contains the catalyst will be at temperatures significantly lower than the adiabatic combustion temperature of the gas. Generally, neither the bulk outlet gas temperature nor the wall temperature will be more than about 800° C., and preferably below 750° C. In addition, the catalyst temperature should not exceed 1000° C. and preferably not exceed 950° C. These temperatures will depend on a variety of factors including the pressure of the system, the partial pressure of oxygen, the caloric content of the fuel, and the like. Nevertheless, the catalyst will combust the fuel, but it will limit the ultimate temperature to a value lower than the adiabatic combustion temperature because a large fraction of the heat released by the combustion reaction will be absorbed by the (endothermic) steam reforming reaction on the other side of the separator plate. The ability to limit combustion temperatures by transferring the heat of combustion from the combustion catalyst to the reforming catalyst through a solid phase (metal) allows the design of smaller reactors operating at lower temperatures than those proposed in the prior art.

Reforming Zone

The reforming fuel is mixed with steam to produce a mixture having an H₂O:C ratio 1, preferably in the range of from about 1 to about 5, and most preferably about 3±0.5. The mixture may be at atmospheric pressure or it may be compressed. In a presently preferred best-mode embodiment, the process employs catalytic amounts of palladium-containing and rhodium-containing materials on a support having low resistance to gas flow.

The steam/fuel mixture supplied to the catalyst should be premixed well and the inlet temperature may be varied depending on the fuel used. This temperature may be achieved by preheating the mixture through heat exchange. Reforming catalyst temperatures will be essentially the same as the combustion catalyst temperature, because heat transfer resistances in the thin foil or platelet-type separator plate are typically negligible.

Separator Plate

The preferred materials for the separator plate foils or platelets include: aluminum-containing or aluminum-treated steels; stainless steels suitable for thermal reaction environments; and any high-temperature metal alloy, including cobalt or nickel alloys where a catalyst layer can be deposited on the metal surface.

The preferred materials for the foils and platelets are aluminum-containing steels, such as those found in U.S. Pat. No. 4,414,023 to Aggen et al., U.S. Pat. No. 4,331,631 to Chapman et al., and U.S. Pat. No. 3,969,082 to Cairns, et al., the disclosures of which are hereby incorporated by reference to the extent needed for full description of the composition and properties of such steels. These steels, as well as others available from Kawasaki Steel Corporation (River Lite 20-5 SR), Vereinigte Deutchse Metallwerke AG (Alumchrom I RE), and Allegheny Ludlum Steel (Alia-IV), contain sufficient dissolved aluminum so that, when oxidized, the aluminum forms alumina whiskers or crystals on the sheet surface in order to provide a rough and chemically reactive surface for better adherence of the catalytic coating.

The catalytic coating may be applied in the same fashion one would apply paint to a surface, e.g., by spraying, direct application, dipping the support into the catalytic material, and the like procedures. Catalytic materials suitable for combustion of fuels, and methods for depositing those materials on the combustion side of the separator plates, are described in U.S. Pat. No. 5,259,574 of Dalla Betta et al., the disclosure of which is hereby incorporated by reference. Those catalytic coating compositions are typically mixed oxides such as silica/gamma alumina, or, most preferably, silica/zirconia, containing dispersed palladium metal or dispersed mixtures of platinum and palladium.

The reforming side of the separator plate is coated with one or more catalytic materials suitable for the reforming of fuels. Common reforming catalysts include mixed oxides such as NiO—MgO—Al₂O₃ with small additions of CaO and K₂O. It should be noted, however, that nickel-based catalysts facilitate the formation of undesired carbonaceous deposits. The heavier the fuel, the more serious is the problem of carbon deposition. Rhodium-based reforming catalysts have been proposed as an alternative to nickel-based catalysts because carbon forms on rhodium catalyst compositions at a reduced rate, as compared to Ni-based catalysts. Rhodium metal can be dispersed on alumina, zirconia, or zirconia modified with additives such as Ce and La to increase catalytic activity and stability, the latter referring to the ability to maintain catalytic activity for a longer period of time, thus leading to longer service life. Other platinum group metals, notably Pd and Ru, may be used as reforming catalysts.

Catalyst Preparation

After alumina whiskers formation, the aluminum/steel alloy sheets, foils or platelets are treated with inert zirconium-containing compounds, preferably, a suspension or sol of zirconium oxide or hydrated zirconium oxide containing the selected catalyst metals (e.g., Pd, Ru, Rh). The zirconia-based sols typically contain mixed oxides of silicon or titanium and additives such as barium, cerium, lanthanum to enhance the catalytic activity and thermal stability of the material. The catalyst metals are fixed on the inert oxide powder prior to coating the steel sheet by impregnating the zirconium oxide powder with the metal salts followed by heat treatment in air. The catalyst metal/inert oxide mixture may then be milled to form a colloidal sol. The resulting sol is applied to the substrate by spraying, dipping, roller coating, brushing, or the like, preferably by spraying. After application of the suspension, the sheets, platelets or foils may be dried and heat-treated in air to form a high surface area oxide layer firmly adhered on the metal surface.

An alternate process for applying the catalyst layer to the support structure is first to deposit a coat of the inert zirconia-based compounds, called a washcoat, followed by adding the catalytic metals to the inert oxide layer by applying a solution of a salt of the catalyst metal (as a precursor of the metal itself). In more detail, the washcoat layer is applied to the sheet support by brush or roller coating, by spraying, or by dipping the sheet into the sol material. After applying the washcoat to the sheet surface, the coated sheet is heat-treated in air to promote bonding of the washcoat to the alumina whiskers or crystals on the sheet surface. Next, metal salt precursors such as palladium nitrate or rhodium chloride are applied (by spraying, dipping brush, or roller) to the washcoat layer. The materials are then heat-treated in air to decompose the metal salts and secure the catalyst metals to the washcoat in an evenly dispersed coating, predominantly very fine crystallites.

### EXAMPLES

### Example 1

Production of Separator Plates Coated with a Pd Catalyst on a Zirconia Support.

A Pd-impregnated zirconia sol was prepared following the procedure taught in U.S. Pat. No. 5,259,754, Example 1, the disclosure of which is hereby incorporated by reference. An Fe/Cr/Al metal foil was oxidized in ambient air at 900° C. for ten hours to form alumina whiskers on the foil surface. The colloidal Pd/ZrO₂ sol was sprayed onto both sides of the corrugated foil. The coated foil was then heat treated for ten hours in air at 700° C. The final foil contained 10 mg Pd/ZrO₂/cm² foil surface, and this dual-surface catalytic foil is used to form separator plates in a reactor design of this invention.

### Example 2

Reactor Operation

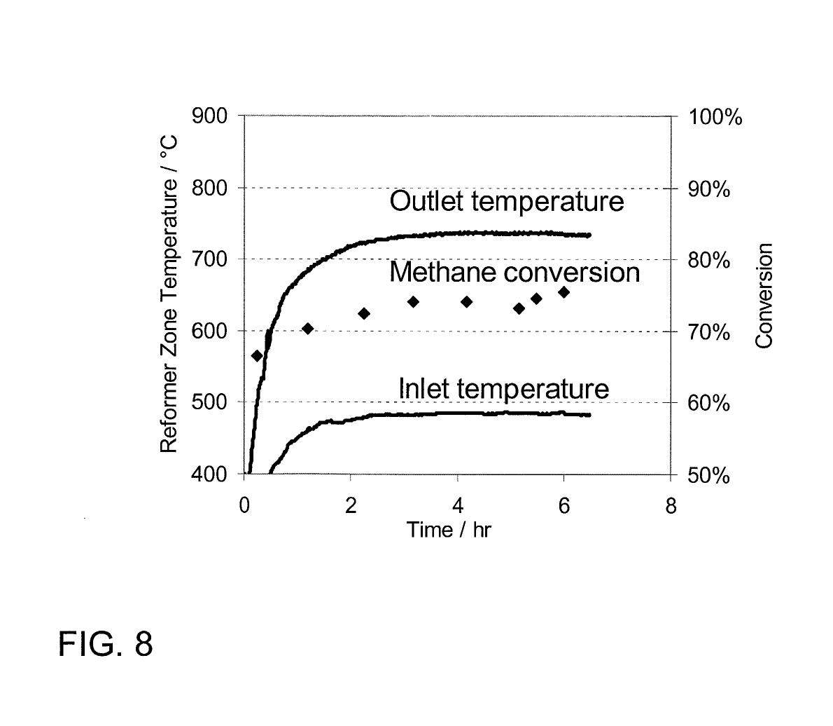

Two separator plates constructed of the foil prepared in accordance with the procedure of Example 1 were employed in a reactor of the design illustrated in FIG. 7 (described above) and tested. Flow-directing devices illustrated in FIG. 6 were inserted in the reforming and combustion channels. The air flow rate in the test was 100 SLPM; the fuel was natural gas supplied at a flow rate of 3 SLPM both on the combustion and reforming channels, the steam/methane molar ratio was 3.0, and the steady state preheat temperature for all inlet streams was 485° C. The performance of those plates is shown in FIG. 8. Solid trace lines in this figure denote reformer zone inlet and outlet temperatures versus runtime. The Temperatures were measured in the reforming channel at the upstream and downstream edges of the catalyst coating R (see positions 60 and 62, respectively, in FIG. 6). An overlay plot shows the conversion of methane versus runtime, the diamonds representing the conversion of methane to H₂, CO, and CO₂. After approximately three hours on stream, the system was at a steady state with reforming zone inlet temperature matching the preheat temperature of 485° C. and outlet reforming zone temperature registering approximately 740° C. Methane conversion remained essentially constant in the range of about 74-78% for the 3½ hr. duration of the steady state portion of the test.

The temperatures in the reformer zone of the present bi-catalytic plate reformer invention are much lower than those observed in conventional steam reforming processes. More significantly, they are also lower than those reported in prior art, non-catalytic plate reformers. For example, the reformer described in U.S. Pat. No. 5,015,444 of Koga et al. operates with an inlet temperature of 650° C. and an outlet temperature of 850° C. Those temperatures are over 100° C. higher than the temperatures of operation of the catalytic reformer of the present invention. Low temperatures of operation result in longer catalyst life and decreased thermal losses.

### Example 3

Production of Separator Plates Coated with a Combustion Catalyst on One Side and a Reforming Catalyst on the Opposite Side.

In this example, the combustion catalyst is a palladium catalyst on a zirconia support coated on one side of a foil separator plate as indicated in Example 1. The reforming catalyst is a rhodium catalyst on a zirconia-modified support coated on the other side of the same foil in process steps as follows: ZrO₂ powder (modified by the addition of ceria and lanthana) was impregnated with a solution of RhCl₃. The final Rh loading was 5 wt %. The Rh-impregnated zirconia paste was dried at 120° C. overnight. It was then heat treated at 200° C. for 2 hrs followed by heat treatment in ambient air at 500° C. for 4 hrs. This solid material was mixed with water acidified with sulfuric acid to a pH of about 3, and ball milled in a polymer lined ball mill using a zirconia grinding media for ten hours. This colloidal Rh/ZrO₂ sol was diluted to a concentration of 15% ZrO₂ by weight with additional water. An Fe/Cr/Al metal foil was oxidized at 900° C. in air for ten hours to form alumina whiskers on the foil surface. The colloidal Pd/ZrO₂ sol was sprayed onto one side of the metal foil and dried. Then, the colloidal Rh/ZrO₂ sol was sprayed onto the opposite side of the metal foil and dried. The coated foil was then heat-treated at 700° C. for ten hours in ambient air. The final foil contained 10 mg Rh/ZrO₂ /cm² on one face and 10 mg Pd/ZrO₂ on the opposite face.

### Example 4

Reactor Operation.

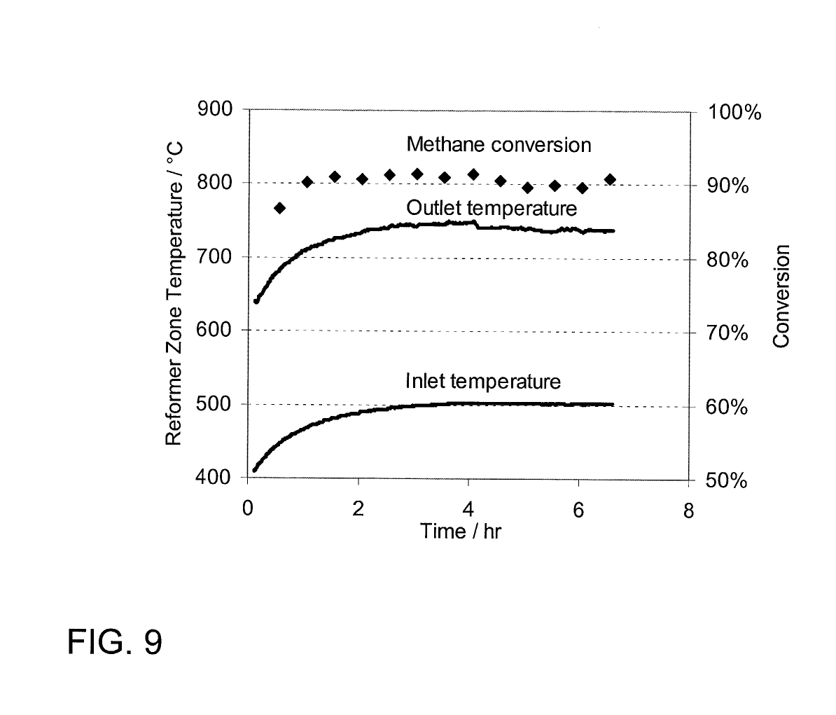

Two bi-catalyst separator plates constructed from the foil prepared as in Example 3 were employed in a reactor of the design of FIG. 7, and tested. The air flow rate was 100 SLPM, the natural gas flow rate was 3 SLPM through both the combustion and reforming channel zones, and the steady state preheat temperature for all inlet streams was 500° C. The performance of the reformer reactor employing bi-catalytic separator plates of the invention is shown in FIG. 9. This figure shows plots of reformer zone inlet and outlet temperatures (solid traces), and conversion of methane, versus runtime (diamonds). After approximately three hours on stream, temperatures were at a steady state with reforming zone inlet temperature matching the preheat temperature of 500° C., while outlet reforming zone temperature was approximately 740° C. Methane conversion was over 90% after 90 minutes on stream and essentially constant at 89-92% for the remaining 5+ hrs of the test. While we do not wish to be bound by theory, we believe that steady-state values for methane conversion were obtained before the reformer reached steady state temperatures because reforming reaction rates on the rhodium catalyst are high enough that the performance of the reformer is limited by the rate of diffusion of methane to the catalytic surface from the feed gas stream.

Comparison of the graphs in FIGS. 8 and 9 show that the Rh reforming catalyst provides substantially improved methane conversions as compared to the Pd reforming catalyst, 89-92% vs 74-78%, at close to equilibrium operating conditions, with more consistent conversion, yet the reformer zone using the Rh catalyst operates at the same low temperatures as in the case of Pd catalyst (Ex. 2).

These examples show that the bi-catalytic reactor of the invention can be used to reform methane driving the reaction essentially to chemical equilibrium while keeping reactor temperatures significantly lower than those observed in the prior art. Low temperatures of operation are necessary to insure long catalyst durability. In accord with the invention the reformer zone functions in the temperature of below about 850° C., and preferably in the range of from about 650° C. to about 800° C., and most preferably in the range of from about 700° C. to about 775° C. for methane conversion to hydrogen. As compared to the prior art for a wide range of feeds, the temperature drop in the reforming zone is on the order of about 100-200° C. Corresponding improvements in conversion percentages and lowered reforming zone operating temperatures, as well as longer service life will be obtained using other hydrocarbon fuels of the classes listed above. Also, the combination of high-activity combustion and reforming catalyst materials coated on bi-catalyst plates and flow-directing devices provide high local heat and mass transfer rates and high reaction rates that result in a very compact system suitable for use both in stationary and mobile fuel cell power systems.

It should be understood that the development of the whiskers on the surfaces of the separator platelets is only one example of surface preparation for deposition of the catalyst composition, and both chemical and mechanical treatments can be employed to prepare one or more of the surfaces for good mechanical adhesion and/or chemical bonding (be it coordination, hydrogen, covalent, chelation- or other type of chemical or quasi-chemical bonding). Thus the surface can be mechanically textured, as by abrading, grinding, embossing, or the like, or chemically etched or pretreated, or chemically/mechanically prepared to accept catalytic composition deposition. The chemical catalysts included within the scope of the invention include the same or different catalyst compositions deposited on the respective obverse surfaces or faces of the platelets, it being understood that in the case of catalyst compositions using one metal or a combination of more than one metal, different ratios of the metals, surface loadings, as-deposited crystallite size, and the like, of the metals as between two compositions are considered to be different compositions. Thus, while the combustion and reforming catalyst compositions may contain the same metal or metals, they can be very different in one or more of the above factors. Further, since the feedstock gases composition supplied to the respective reaction zones may be different, the reactivity and steady state conversion and equilibrium temperatures can vary, even with the same catalyst used for both the combustion and reforming zones.

Industrial Applicability

It should be clear that the bi-catalytic separator plate modular multi-cell reformer apparatus and methods of the invention will find wide industrial applicability, particularly in association with modular fuel cells and for process chemistry requiring hydrogen rich gas for chemical reactions, such as for polymerization where hydrogen is a reaction modifier. In the fuel cell field, the inventive reformer will find particular use in connection with modular fuel cells used for residential and light industrial power, and for water treatment, such as production of potable water from seawater and other non-potable sources. Use of the modular reformers of the invention in connection with fuel cells for hybrid power sources for mass transit and industrial hauling vehicles is also feasible.

The invention has been disclosed both by description and by the use of examples. The examples are only exemplary of the principles of the invention and are not intended to limit the invention in any way. It should be understood that various modifications within the scope of this invention can be made by one of ordinary skill in the art without departing from the spirit thereof. It is therefore intended that this invention shall be defined by the scope of the appended claims as broadly as the prior art will permit, and in view of the specification if need be, including equivalents thereof.

1. A continuous-flow catalytic plate reactor for performing an endothermic reaction and an exothermic reaction in adjacent isolated reaction chambers to supply the heat required by said endothermic reaction by said exothermic reaction, comprising:
a) a stack of catalyst-coated platelets interleaved with transverse-flow plates, each of said catalyst-coated platelets and said transverse-flow plates comprising four apertures arranged in a spaced, substantially rectangular array and disposed as a first pair of apertures adjacent one end and a second pair of apertures adjacent a spaced, opposed end, all four apertures of one plate being aligned with all four apertures of all other plates of said stack;
b) each of said catalyst-coated platelets being impermeable to gas flow through said platelets and each having a coating of catalyst for said exothermic reaction on one side and a coating of catalyst for said endothermic reaction on the other side;
c) each of said transverse-flow plates includes a void region medial in said plate joining only one of said pairs of apertures to expose said catalyst coatings on both adjacent catalyst-coated platelets, which platelets form the side walls of said flow plate void region to define a reaction zone therebetween, said transverse-flow plates alternating between those in which said void region joins said first pair of apertures and those in which said void region joins said second pair of apertures;
d) said apertures and reaction zones defining two non-commingling flow paths through said stack;
e) the first of such flow paths extending from one of the aligned apertures of said first pair through the reaction zone of every second traverse-flow plate while passing over said coating of catalyst for said exothermic reaction to the remaining one of the first pair of aligned apertures; and
f) the second of such flow paths extending from one of the aligned apertures of said second pair through all remaining reaction zones while passing over said coating of catalyst for said endothermic reaction to the remaining one of the second pair of aligned apertures.

2. A continuous-flow catalytic plate reactor as in claim 1 in which said first pair of apertures is arranged diagonally in said rectangular array and said second pair of apertures is arranged diagonally in said rectangular array transverse to said first pair.

3. A continuous-flow catalytic plate reactor as in claim 1 in which one of said aligned apertures in each pair is defined as a feed channel and the remaining one of said aligned apertures in each pair is defined as a product channel, and wherein said feed channel is terminated by a flow stopping member to force flows from said feed channel through said reaction zone to said product channels

4. A continuous plate reactor as in claim 1 in which said catalyst-coated platelets are substantially thinner than said transverse-flow plates.

5. A continuous plate reactor as in 1 in which the void region of every traverse-flow is partially filled with means for redirecting gas flow into contact with at least some of said catalyst coated on said reaction zone side wall.

6. A continuous plate reactor as in claim 5 wherein said flow directing means comprises a groved metal plate.

7. A continuous plate reactor as in claim 5 wherein said flow directing means comprises metal or ceramic spheres.

8. A continuous plate reactor as in claim 1 wherein said separator platelets comprise an aluminum-containing iron alloy coated with catalyst.

9. A catalytic plate reactor as in claim 1 wherein said coating of catalyst for said exothermic reaction is a combustion catalyst, and said catalyst for said endothermic reaction is a steam reforming reaction catalyst

10. A method for performing an endothermic reaction and an exothermic reaction simultaneously in isolated adjacent reaction chambers to supply heat required for said endothermic reaction by said exothermic reaction, said method comprising:
a) passing an endothermic reaction feed gas stream and an exothermic reaction feed gas stream through a stack of generally planar reaction zones comprising catalyst-coated platelets interleaved with relieved transverse-flow plates, each of said catalyst-coated plates and said transverse-flow plates comprising four apertures arranged in a substantially rectangular array and defined as a first pair of apertures and a second pair of apertures, all four apertures of one plate being aligned with all four apertures of all other plates of said stack;
b) each of said catalyst-coated platelets being impermeable to gas flow other than through said apertures and each having a coating of catalyst for said exothermic reaction on one side and a coating of catalyst for said endothermic reaction on the other side;
c) each of said transverse-flow plates further comprising a void region medial thereof which joins only one of said pairs of apertures to expose said catalyst coatings on both adjacent catalyst-coated plates and form a reaction zone therein, said transverse-flow plates alternating between those in which said reaction zone joins said first pair of apertures and those in which said reaction zone joins said second pair of apertures;
d) said endothermic reaction feed stream and said exothermic reaction feed stream are fed through two non-commingling flow paths through said stack;
e) the first of such flow paths extending from one of said aligned apertures of said first pair through the reaction zone of every second transverse-flow plate while passing over said coatings of catalyst for said exothermic reaction to the remaining one of said aligned apertures of said first pair;
f) the second of such flow paths extending from one of said aligned apertures of said second pair through all remaining reaction zones while passing over said coatings of catalyst for said endothermic reaction to the remaining one of said aligned apertures of said second pair;
g) generating heat at said coatings of catalyst for said exothermic reaction and conducting said exothermic heat through said separator platelets directly to said coatings of catalyst for said endothermic reaction to accelerate said endothermic reaction.

11. A method in accordance with claim 10 in which said first pair of apertures is arranged diagonally in said rectangular array and said second pair of apertures is arranged diagonally in said rectangular array transverse to said first pair.

12. A method in accordance with claim 10 in which said exothermic reaction is a combustion reaction and said coating of catalyst for said exothermic reaction is a combustion catalyst, and said endothermic reaction is a steam reforming reaction and said catalyst for said endothennic reaction is a steam reforming reaction catalyst.

13. A method of producing a catalytic wall plate reactor comprising the steps of:
a) brazing two transverse-flow plates to opposite faces of a thin metal platelet to make a sub-assembly;
b) coating at least a portion of the exposed surface of one side of the thin metal platelet with a combustion catalyst;
c) coating at least a portion of the exposed surface of the opposite side of the thin metal plate with a reforming catalyst;
d) cleaning the exposed surfaces of the transverse-flow plates; and
e) brazing a stack of the subassemblies to form a plate reactor.

14. A method of producing a catalytic wall plate reactor comprising the steps of:
a) brazing a metal frame to each of opposite faces of a transverse-flow plate to make a sub-assembly;
b) coating at least a portion of one side of a thin metal platelet with a combustion catalyst;
c) coating at least a portion of the opposite side of the thin metal platelet with a reforming catalyst, said bi-catalyst coated platelet forming a separator platelet; and
d) forming a stack of catalyst coated platelets interleaved with said subassemblies, including placing inert, thermally resistant gaskets between the subassemblies and separator platelets.

15. A modular reactor sub-assembly for a continuous flow plate reactor comprising in operative combination:
a) a separator platelet having a first surface and a second surface on the obverse side thereof, a longitudinal dimension terminating in first and second ends, and a lateral dimension generally orthogonal thereto terminating in first and second side edges;
b) said platelet having deposited on selected areas on at least one of said first and said second surfaces a coating of at least one catalyst compositions, said catalyst compositions being selected from the same or different compositions;
c) at least one first reactant gas flow plate disposed on said first side of said first separator plate;
d) at least one second reactant gas flow plate disposed on said second side of said first separator plate;
e) each of said first and second flow plates having a relieved area therein substantially corresponding to said selected catalyst composition coated area, said relieved area providing a generally planar reaction zone bounded on one side thereof by said separator platelet selected catalyst coating; and
f) said separator plate and said flow plates having aligned apertures generally located at apposed ends to provide passage of feedstock gases into and out of the respective reaction zones without short circuit and maintaining separate feed streams flow into and out of the respective zones, said gases flow in said reaction zones being selected from co-flow and counterflow.

16. A modular reactor subassembly as in claim 15 wherein said catalyst composition coating on said first platelet surface is different from said catalyst composition coating on said second platelet surface.

17. A modular reactor subassembly as in claim 16 wherein at least one of said flow plate reaction zones includes means for directing gas flow into contact with said catalyst coating separator plate surface.

18. A modular reactor subassembly for a continuous flow plate reactor comprising in operative combination:
a) at least one generally planar first reactant gas flow plate having a first face and a second face on the obverse side thereof, a longitudinal dimension terminating in first and second ends, and a lateral dimension generally orthogonal thereto terminating in first and second edges;
b) said at least one flow plate having a relieved area therein medial of said ends and edges, said area defining a generally planar reaction zone between said faces;
c) a first, generally planar separator platelet disposed on said first face of said flow plate and a second generally planar separator platelet disposed on said second face of said flow plate, said platelets defining side walls for said reaction zone;
d) said platelets each having a first surface and a second surface on the obverse side thereof; at least one of said first surfaces having deposited on selected areas a coating of at least one catalyst composition, said catalyst composition being selected from the same or different compositions and said selected areas of coating being aligned with and not extending beyond said flow plate reaction zone relieved area, and said first surfaces of said platelets on opposed faces of said flow plate facing each other with said at least one catalyst coated platelet area exposed in said reaction zone; and
e) said flow plate and said separator platelets having aligned apertures generally located at apposed ends to provide passage of feedstack gases into and out of said reaction zone.

19. A modular reactor subassembly as in claim 18 wherein both said first surfaces of said platelets are coated with the same catalyst composition.

20. A modular reactor subassembly as in claim 19 wherein both said second surfaces of said platelets are coated with the same catalyst composition, which composition is selected from the same or different catalysts as coated on said first surfaces of said platelets.

21. A modular reactor subassembly as in claim 19 wherein said flow plate reaction zone includes means for directing gas flow into contact with at least a portion of the catalyst composition on at least one of said first separator platelet surfaces.
